(19) United States
(12) Patent Application Publication
(10) Pub. No.: US 2005/0086656 A1
(43) Pub. Date: Apr. 21, 2005

(54) Methods and systems for inter-process copy sharing of data objects

(75) Inventors: David Michael Whitlock, Portland, OR (US); Robert F. Bretl, Portland, OR (US)

Correspondence Address: KLARQUIST SPARKMAN, LLP, 121 SW SALMON STREET, SUITE 1600, PORTLAND, OR, 97204, US

(73) Assignee: GemStone Systems, Inc.

(21) Appl. No.: 10/690,035

(22) Filed: Oct. 20, 2003

(51) Int. Cl. G06F 9/455

(52) U.S. Cl. 718/1

(57) ABSTRACT

Data sharing between multiple computer processes is made possible by brokering the sharing of the state of data objects of interest between the multiple processes via a shared memory location. A state of a data object of interest is flushed from a memory location local to a one of the multiple processes to a shared memory location wherein the flushed state is visible to the rest of concurrently executing multiple processes. The instruction to flush may be explicit or implicit via data references. Similarly, a state of a data object in a memory location local to a process may be refreshed with an updated state available in the shared memory location. The state of data object in a shared memory location or in a local memory location may be determined via data reflection or if so specified, by serialization methods. The flush and refresh operations may be implemented as function calls exposed to the processes requesting data sharing.

### TECHNICAL FIELD

The technical field relates to data sharing between computer programs. More particularly, the field relates to methods and systems for persistently sharing data objects between multiple computer processes.

### BACKGROUND

Computer programs often need to share data. For example, two different programs may need to access and possibly manipulate or change the same data related to financial market transactions. Furthermore, as individual programs scale in size, they may require additional computing power to execute their tasks. In operating system environments that support multi-tasking and multi-threading, such scalability may be achieved by spreading a program's multiple tasks across multiple instances of the program (commonly referred to as “processes”) so that these tasks can be performed concurrently. Furthermore, in systems that support just-in-time compilation the execution of multiple processes can be spread across multiple virtual machines. For example, FIG. 1 illustrates a multi-tasking system 105 with two processes 110 and 120 on a computer 100 executing concurrently on two different virtual machines. Such multi-tasking allows for more efficient use of a computer's resources. However, cooperating processes (e.g., 110 and 120) also often access the same data.

Sharing of data among multiple programs or processes raises a number of complexities that a software programmer needs to address. For instance, multiple processes or programs may not only need to access the same shared data but they may also need to change such shared data. Moreover, changes made in the shared data by one process may affect the operations of another process that also has access to the shared data. Thus, a mechanism needs to be in place which allows for changes to shared data made by one process to be made visible or evident to other processes that also share the data.

Sharing data among program instances is not a new problem. A common method for sharing data is to store the shared data in a database that is accessible by all programs or processes. However, for most kinds of data there is significant space and time overhead to persist the data in a database. For instance, before the data can be shared it may have to be transformed into a storage format related to the database. Then the data may have to be written to a disk by the database. Another common solution for sharing application data is to send data between processes using network sockets. Unlike databases, sockets do not write data to disk, however the data may still need to be transformed to a format understood by the sockets. Furthermore, some operating systems only allow a process to allocate a small number of sockets. As a result, applications that share data using sockets may not be able to scale to a large number of concurrent processes.

One approach to addressing the problems evident in the systems described above may be described as shown in FIG. 2, wherein two different processes (e.g., 210 and 220) are shown being executed on two different virtual machines 225 and 215 each having a local copy 230A and 230B of the shared data within their own memory space. However, memory space local to a process may not be visible or accessible to other concurrently executing processes. Thus, as each virtual machine manipulates their individual copies of the data objects (e.g., 230A and 230B) these changes are not evident to the other virtual machines that are concurrently executing other processes that may also be manipulating the same data. Thus, a programmer may need to code instructions that write a copy of the shared data 230C to a shared memory location 240 and instructions to read from the same shared location 240. Such low level programming is not only arduous and time consuming, it is also well beyond the capabilities of most programmers. However, there are data sharing tools (e.g., Direct Sharing model of GemFire™ by GemStone® Systems of Beaverton, Org.) that allow data to be shared transparently among programs written in different programming languages without the programmer having to provide the low level instruction code necessary to read from and write to a shared memory location.

The direct sharing model in GemFire™ provides a common object-oriented data abstraction and allows data to be shared directly among processes. To use the direct sharing model, a computer programmer may need to post-process his or her program after the compilation phase. Such post-processing converts process-local data accesses to shared data accesses. The direct sharing model requires very few source code modifications and for the most part the programmer may code as if the shared data is available within a memory space local to the virtual machines (e.g., 225 and 215). Direct sharing model allows data to be shared without modifying its structure. As shown in FIG. 3 in a direct sharing model, process data 345 resides in a shared memory segment 340 that is visible to multiple processes (e.g., 310 and 320). Since the shared memory segment 340 is mapped into the processes' address space, accessing such shared data is often faster than sending the same data over a socket. The data 345 may be stored in an “object” format similar to application objects. This allows the data to be delivered to the application with minimal transformation overhead.

The direct sharing model makes reading and writing to shared memory space 340 transparent to an application programmer by post processing a program to automatically access data in shared memory. This is implemented in direct sharing by using an enhancer 330 to annotate the application's code with instructions to directly access data in shared memory instead of data stored locally to the process. This provides for a very natural programming style and allows applications to be easily migrated to a multi-process environment. Direct sharing allows an application to directly access data in shared memory.

To illustrate direct sharing, consider a commodities trading application. Bids and offers for commodities are constantly flowing into the application. The application may have to examine the bids and offers, determine which ones match, and then execute the transaction. Depending on the rules of the exchange, the computations involved in matching the bids and offers may be expensive. So, it may be sensible to divide the work up among multiple processes. However, the data being operated on may change very rapidly. Thus, storing the bid and offer data in shared memory and using direct sharing to access that data allows the application to be distributed among multiple processes with only a minimal set of changes.

For instance, the application might store bid and offer data in an instance of a class type named Price that contains three fields that describe the name of the commodity being traded, the name of the trader that has made the offer or bid, and the value of the price. A definition of such a class may be as follows:

class Price {
String commodityName;
String traderName;
double price;
}

The original application may contain functionality for processing bids and offers which is implemented using the Price class. When the application is migrated to operate using multiple processes, the programmer may specify that fields of instances of the Price object should be stored in shared memory using a direct sharing model. As a result, when building the application from its source code, the programmer may run the enhancer 330. When the application executes, every time a field in a Price object 345 is accessed, the program will fetch or store its value from shared memory 340. Thus, when one part of the application (e.g., 310 or 320) modifies a Price object (e.g., when a trade is completed), the data 345 stored in shared memory 340 is updated and is immediately visible to other parts of the application that may be running in different processes.

Direct sharing is more suitable for situations when data changes very often and changes made by one process needs to be immediately visible to other processes sharing the same data. However, a lot of the data shared between processes may be static and do not need to be updated frequently. Furthermore, repeatedly accessing data in shared memory 340 is much slower than accessing data stored in the process' memory space itself. Additionally, some programmers may not be comfortable with the enhancer tool 330 modifying their code. Thus, there is a need for a data sharing model which addresses some these shortcomings of the direct sharing model and some of the shortcomings of other models described above.

### SUMMARY

Described herein are simplified methods and systems for sharing data objects between concurrently executing processes. Data objects created or updated within one process may be flushed to a shared memory location and made accessible to the rest of the processes. A memory location local to a process may be refreshed with the state of data objects from a shared memory location. Both the flush and the refresh operations may involve updating an existing data object respectively in shared memory or a local memory or they may also involve creating a new data object.

In one aspect, the flush and refresh operations may be invoked by the way of explicit instructions. In another aspect, they may be invoked implicitly for those data objects that are referred to within the data objects for which the flush or the refresh operations are invoked explicitly.

In yet another aspect, the flush and refresh operations may be implemented as methods to be called on a copy share helper module which can broker the data sharing between processes via one or more shared memory locations. In one aspect, the data objects to be flushed or refreshed may be specified as parameters of their respective methods. Also, data objects may be flushed or refreshed simultaneously in sets or groups or individually. For example, data objects to be flushed or refreshed can be collected in a dirty set and then flushed or refreshed at once. Also, methods are described herein for implicitly flushing or refreshing data objects referred to within data objects that are explicitly refreshed.

In a further aspect, the state of a data object may be determined, in a shared memory or in a local memory location, by using data reflection methods. However in a flush operation, upon determining that a data object is serializable, any contract specified for serialization may be honored to store a serialized form of the data object in a shared memory location. A default serialization method may be used if no contract is specified. Furthermore, a modified serialized form of a data object is described herein which comprises information related to a data object's structure such that it may be browsed by an object browsing tool. Also, in a refresh operation, upon determining that a data object in a shared memory location is in a serialized form, the serialized form of the data may be reconstituted to an object graph form prior to being stored in a local memory location.

Additional features and advantages of the systems and methods described herein will be made apparent from the following detailed description that proceeds with reference to the accompanying drawings.

### BRIEF DESCRIPTION OF DRAWINGS

FIG. 1 is a block diagram illustrating a multi-tasking system executing multiple processes concurrently.

FIG. 2 is a block diagram illustrating the concurrently executing multiple processes of FIG. 1 sharing data objects.

FIG. 3 is a block diagram illustrating a direct sharing model for sharing of data objects between multiple processes.

FIG. 4 is a block diagram illustrating a copy sharing model for sharing of data objects between multiple processes.

FIG. 5 is a flow chart of an exemplary overall process for implementing flushing of data objects from process' local memory to a shared memory in a copy sharing model.

FIG. 6 is a flow chart of an exemplary overall process for refreshing a process' local memory with a copy of a data object from a shared memory location in copy sharing model.

FIG. 7 is a flow chart of an exemplary detailed process for flushing a data object using data reflection or data serialization.

FIG. 8 is a flow chart of an exemplary detailed process for refreshing a data object using data reflection or data serialization.

FIG. 9 is a listing of code implementing copy sharing of an exemplary Department object.

FIG. 10 is a listing of code implementing copy sharing wherein an exemplary Employee object referred to by a Department object of FIG. 9 is copy shared by explicit flushing and refreshing.

FIG. 11 is a block diagram illustrating the operations of the code listings of FIGS. 9 and 10.

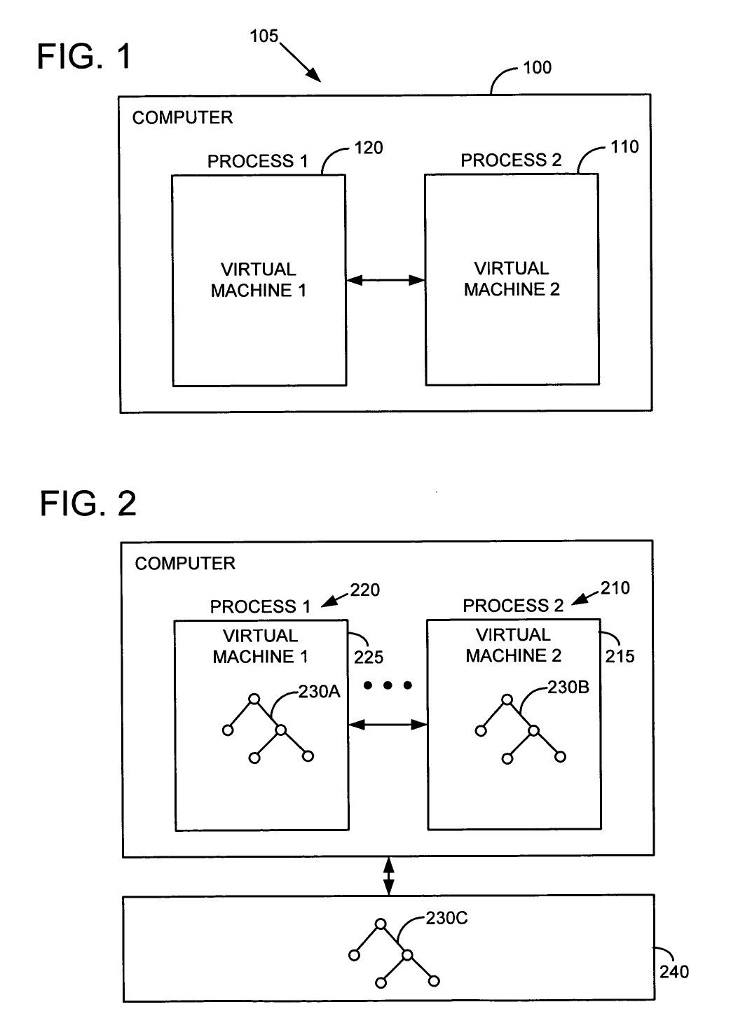

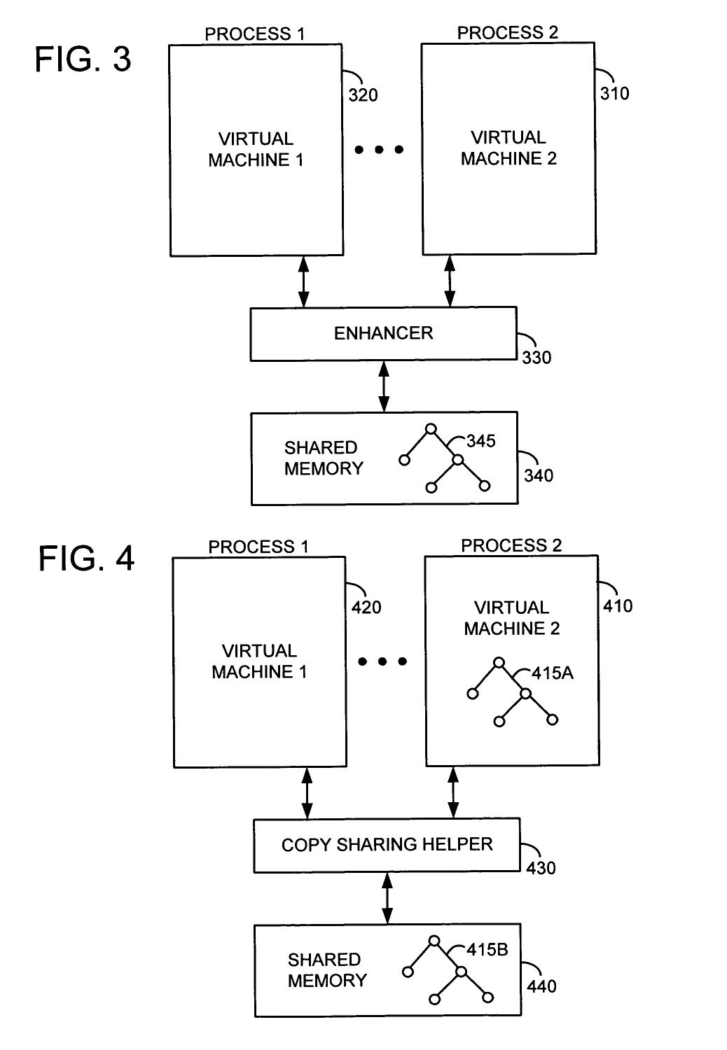

### DETAILED DESCRIPTION

### An Overall Description of an Exemplary Method for Copy Sharing

The problems associated with direct sharing (e.g., the overhead associated with automatically accessing data objects from a shared memory, undesirability of annotating an application program's code etc.) may be addressed by implementing a copy sharing model. In one embodiment of a copy sharing model, data may be shared between multiple processes in a shared memory and instead of reading and writing data objects directly to the shared memory (e.g., upon the execution of each transaction related to the shared data), copies of the shared data objects are made in a memory space local to each process as and when it is needed. The process can then use the local copy of the data object and make changes if necessary and later on the shared state of the data object may be updated with the changes made to the local copy. Thus, unlike direct sharing in which shared data is accessed automatically, in copy sharing data may be explicitly fetched and stored data from shared memory.

FIG. 4 illustrates an exemplary system for implementing a copy sharing model in which multiple processes (e.g., 410 and 420) may share data objects (e.g., 415A) stored in a shared memory space 440. When a data object (e.g., 415A) is created or updated in a process 410 it may be explicitly flushed to place a copy 415B of it in the shared memory space 440. Similarly when a process 420 needs to access a shared data object 415B a memory space local to the process 420 may be refreshed with a copy of the data object from the shared memory space.

The flushing and refreshing of data objects between processes and their shared memory may be brokered by a copy share helper 430, which may provide for methods which can be explicitly called in program code related to the processes 410 and 420. Thus, data sharing may be enabled through a copy sharing helper without the need to annotate or otherwise alter any compiled code related to the processes 410 and 420. The data in shared memory 440 may be stored in a structured object format described by a shared class. A shared class may be identified by a name and consists of zero or more fields. Each field may have a name and specify a type of data it may store. A field's type may be either a primitive, such as a number or a string of characters, or a shared class.

### An Overall Method for Copy Sharing Using Explicit Flushing of Data Objects from Process' Local Memory Space to a Shared Memory Space

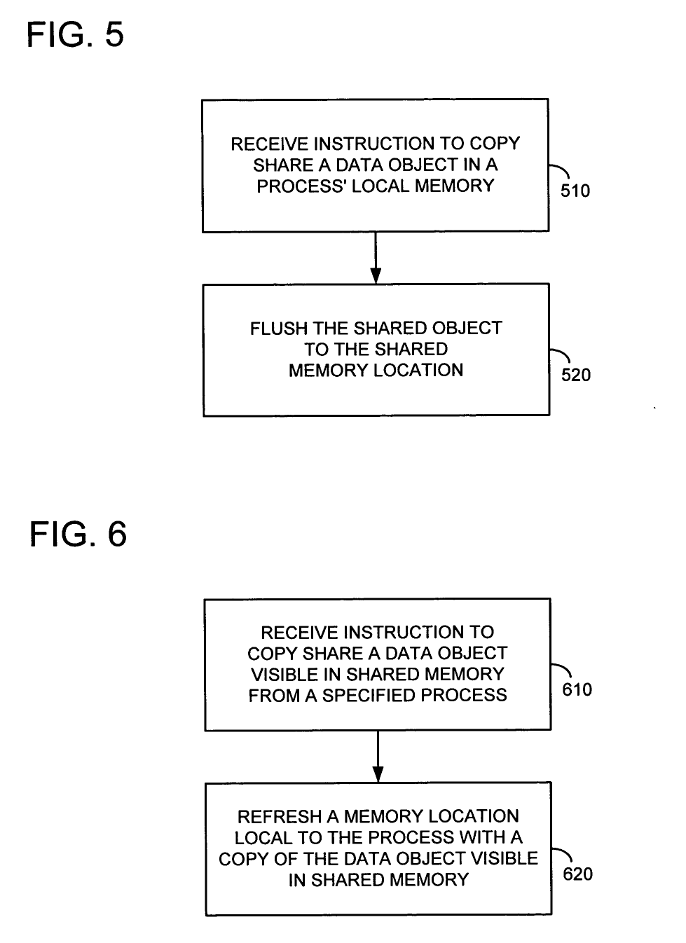

FIG. 5 shows one example of a overall method for implementing data sharing through copy sharing. At 510, an instruction is received to flush a specified copy of a data object in a process' local memory to a specified shared memory location. In response, at 520, the specified copy of the data object is flushed to the shared memory location. The request to flush is thus explicit and may come from code related to the one of the concurrently executing processes (e.g. 410 and 420). Alternatively, such instructions may be received from outside any of the concurrently executing processes (e.g., 410 and 420). The instructions may be directed to a copy sharing helper module 430, which is capable of responding to such requests.

Besides copy sharing entire individual data objects with all their data members, individual data members too may be specified and copied. For instance, if a change in a local copy of a data object only corresponds to some selected fields of the object only those fields may be flushed to update an existing copy of the data object in shared memory. However, copy sharing model may be most efficient when working with large amounts data because each flush or refresh may be explicit and could increase the coding needed to implement data sharing. Furthermore, larger sets of data objects may be collected to form one data unit that can be flushed or refreshed together. For instance, as a process touches and changes various data objects in its local memory it can collect such changed data objects in a dirty set that can be flushed together at once to improve efficiency of the flushing and refreshing processes.

### An Overall Method for Copy Sharing Using Explicit Refreshing of Data Objects from Process Space to a Shared Memory Space

As shown in FIG. 6, in complement to the process of flushing is a process of refreshing, wherein copies of data objects in a shared memory are used to update, or replace copies of the data objects in a memory space local to a specified process. Sending new copies of data objects from shared memory space to local memory space of a process may also be referred to as refreshing. At 610, an explicit instruction is received to refresh a local memory space of a specific process with a copy of a shared data object located in a shared memory. In response, at 620, the local memory space of the specified process is refreshed with the copy of the data object in the shared memory. As was discussed above with reference to the flushing process 500, the source of the explicit instruction for refreshing may be the process itself or other processes. Also, data objects or its components can be moved in varying configurations and segments without restrictions on the type or amount or quantity of data.

In other embodiments, not all flushing and refreshing of data objects may be explicit. For instance, the first time a process creates a data object in a local memory location it may also execute instructions to designate such an object as a shared object. For instance, this may be accomplished by binding the newly created object to a shared name space such that the object is implicitly flushed to the shared memory without the need to execute an explicit flush instruction (e.g., an explicit flush method implemented in a copy share helper). Furthermore, a data object may be implicitly shared when a reference to it is stored in another object. These implicit flushes may be illustrated with the following example. Referring back to the example regarding a commodities exchange application above, suppose the class definition for a Price class has another field related to an Address class that is defined as follows:

class Price {
String commodityName;
String traderName;
double price;
Address traderAddress
}
class Address {
String street1;
String street2;
String city;
String state;
int zipCode;
}

The first time a process flushes a given instance of a Price object which refers to a Address object, the data related to the Address object may automatically be copied into the shared memory without the need for an explicit flush. In this manner a programmer task of data sharing may be simplified by simply making the assumption that by instructing to flush an object they also intended to flush the data related to other objects referred to within the explicitly shared object. Alternatively, if a copy of the specific Address object is already present in the shared memory space, an implicit flush may not be executed and instead, such data objects may await an explicit flush instruction. Similarly, refreshes may be made implicit instead of explicit under some circumstances.

For instance when a shared object is first refreshed into a process' local memory space then every other object reachable from the refreshed object may also be read into the requesting process' memory space. Alternatively, greater control may be given to a programmer by ensuring that an object is only implicitly refreshed in a process' memory space if a copy of the object is not already in that memory space. In that event, the refresh may happen upon an explicit flush instruction. For instance, suppose a new object “A” is read into a process' memory, and suppose it refers to a previously copy shared object “B” that already exists in that process' memory, in that event, “B” may not be refreshed at that time. However, since the shared state of “B” may be more current or up to date than the local copy of “B” the process may need instructions to explicitly request a refresh. For both the refresh and flush methods the scope of the implicit flush and refresh may be controlled by limiting implicit flushes and refreshes to chosen circumstances.

### Exemplary Detailed Methods for Flushing and Refreshing Data Objects

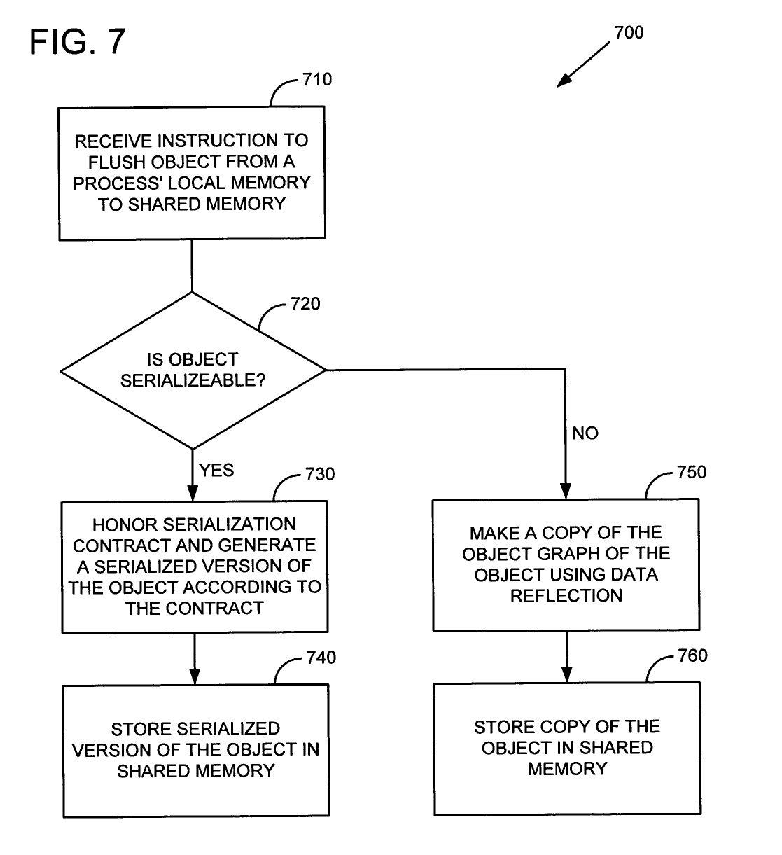

FIG. 7 illustrates an exemplary method 700 for flushing an object. At 710, an instruction for flushing an object from a process' local memory location to a shared memory location may be received. Upon which, at 720, it may be determined whether the object that is being flushed is defined as being serializable according to its class definition. Many programming languages (e.g., Java) provide for methods by which an arbitrarily complex data structure (e.g., object with multiple attributes or fields) can be represented as serial data. For example, an object representing a time, with attributes for year, month, timezone, etc., could be serialized as the string “2002-02-24T14:33:52-0800”, or an XML element “<dateobj year-‘2002’ month=‘02’ day=‘24’ hour=‘14’ minute=‘33’ second=‘52’ timezone=‘−0800’>”, or as a binary string. Storing certain data objects in this form may be desirable because it may be less costly in terms of memory and moreover it may allow for data objects to be fetched or transferred between processes (e.g., via sockets). It is a very familiar concept among programmers and thus, the flushing process 700 leverages this knowledge at 730 by honoring any custom serialization contract associated with the data object by serializing the data according to the contract. Then at 740, according to one implementation, the data may be stored in a shared memory space in a purely serial form or according to another implementation, it may be stored in a modified serial form which may also comprise information related to a structure of an object graph associated with the object being flushed. Storing the data object in a shared memory in a modified serialized form including a structure related to an object graph of the data object may allow for the objects to be browsed by object browsing tools (e.g., GemFire™ Console by GemStone® Systems of Beaverton, Org.).

However, at 720, if it is determined that the data object being flushed is not designated or defined to be serializable, then at 750, a copy of object in a object graph or otherwise browsable form may be made by methodically reading the object using data reflection. Some programming languages (e.g., Java) allow for data reflection mechanisms by which objects in currently executing processes can be examined by another process to determine or extract meta-data such as their class, fields, methods, constructors, their inheritance relationships, etc. In some instances, reflection mechanisms allow for objects to be examined for their meta-data regardless of the visibility rules associated with the objects. Once a data reflection process is complete, at 760, a copy of the data object is made and stored in a shared memory.

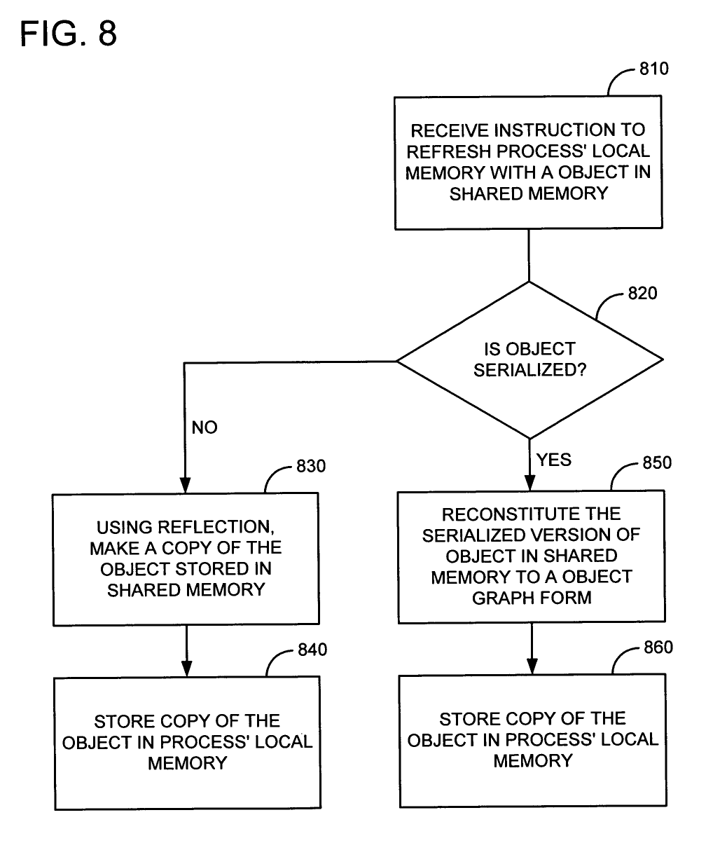

In complement to the process 700 of flushing is a process 800 described in FIG. 8 of refreshing a process' local memory with a data object from the shared memory. At 810, an instruction is received to refresh a process' local memory with an object in the shared memory. Again, as described with reference to the flushing process, the actual process implemented for refreshing may be dependent on whether shared data object is serialized or not. Thus, at 820, it is determined whether the data object is defined to be serialized or not. If it is determined not to be serialized, then at 830, data reflection is used to construct a copy of the data object and at 840 it is stored in a requesting process' local memory. However, at 820, if it is determined that the data object stored in a shared memory is serialized, then at 850, the serialized data object is reconstituted from its serial form to an object graph format and at 860, the object graph is stored the requesting process' local memory.

### Exemplary Implementation of a Copy Sharing Helper API for Copy Sharing

As shown in FIG. 4, in one embodiment, a copy sharing model for data sharing between processes (e.g., 410 and 420) may be implemented by processing instructions related to flushing selected data objects from a process to shared memory 440 where it is visible to other processes and refreshing a local memory of a process with data objects stored in shared memory. According to one embodiment, processing of flush operations and refresh operations and other communications between shared memory 440 and the processes (e.g., 410 and 420) may be via methods implemented in a copy share helper 430. The copy share helper may be a class with several API methods that the processes can call to implement the various flush and refresh operations among other things. In this manner, the low level code for memory accesses and locking mechanisms required for reading and writing to memory may be avoided by a programmer wanting to work with shared data objects. Instead, he or she can use the methods available via the copy share helper 430 to read and write to shared memory. The copy share helper 430 may be adapted to provide methods in a format familiar to most programmers, which allows the copy sharing model to leverage the existing knowledge base of the programmers and reduces their effort.

The following are descriptions of some of the methods that may be made available through the copy share helper 430 that processes 410 and 420 can use to read and write to the shared memory 440:

getInstance:
public static CopyShareHelper getInstance( )

The getInstance method returns a CopyShareHelper instance establishing a connection between the process calling it and the copy share helper 430.

flushObject
public abstract void flushObject(Object o)

The flushObject method flushes the contents of a single object to shared memory. If the object is an instance of a class that implements serialization, then its state will be extracted using a serialization methods, otherwise reflection will be used to extract its state. If the object is an instance of an enhanced class (e.g., a direct shared object) then its state should already be consistent with shared memory and no action is taken.

flushAll
public abstract void flushAll(Object o)

The flushAll method flushes the contents of a single object, as well as implicitly flushing all objects reachable from that object, to shared memory. If any of the objects are instances of a class that implements serialization then their state will be extracted using serialization methods, otherwise reflection will be used to extract their state. If any of the objects are instances of enhanced classes (e.g., a direct shared object) then their state should already be consistent with shared memory and no action is taken.

refreshObject
public abstract void refreshObject(Object o)

The refreshObject method copies the state of a single object from shared memory into a process. If the object is an instance of a class that implements serialization, then its state will be filled in using serialization methods, otherwise data reflection will be used to fill in its state. If the object is an instance of an enhanced class (e.g., a direct shared object) then its state should already be consistent with shared memory and no action is taken.

refreshAll
public abstract void refreshAll(Object o)

The refreshAll method copies the state of a single object, as well as all objects reachable from that object, from shared memory into a calling process. If any of the objects are instances of a class that implements serialization then their state will be extracted using serialization methods otherwise reflection will be used to extract their state. If any of the objects are instances of enhanced classes (e.g., a direct shared object) then their state should already be consistent with shared memory and no action is taken.

addToDirtySet
public void addToDirtySet(Object o)

The addToDirtySet method adds an object to a set of objects that can be flushed or refreshed together in one flush or refresh operation. Note that inclusion in the dirty set is based on an object's identity.

flushDirty
public void flushDirty( )

The flushdirty method writes the contents of each object in the dirty set to shared memory using the flushObject(Object) method described above and removes the object from the dirty set.

flushAllDirty
public void flushAllDirty( )

The flushAllDirty method writes the contents of each object in the dirty set to shared memory using the flushAll (Object) method described above and removes the object from the dirty set.

refreshDirty
public void refreshDirty( )

The refreshDirty method refreshes the state of each object in the dirty set to match its current state in the shared memory using the refreshObject(Object) method described above and removes the object from the dirty set.

refreshAllDirty
public void refreshAllDirty( )

The refreshAllDirty method refreshes the state of each object in the dirty set to match its current state in the shared memory using the refreshall (Object) method described above and removes the object from the dirty set.

### Exemplary Implementation of Copy Sharing

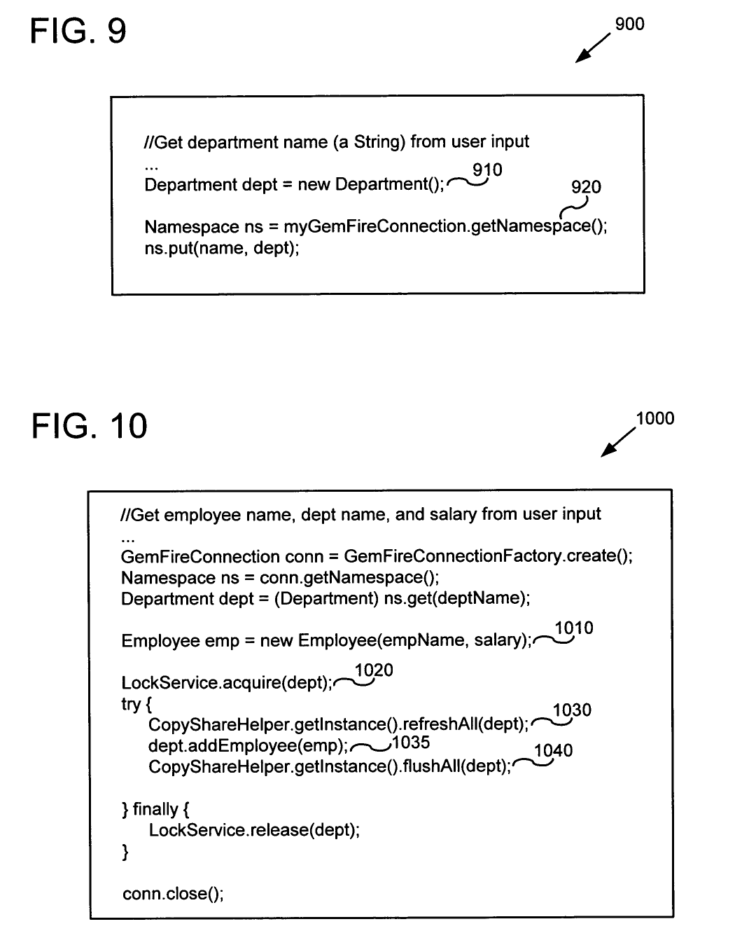

An exemplary implementation of copy sharing is described in the following paragraphs to illustrate the use of copy sharing methods to share data objects between multiple processes. For example, data objects of a defined Department class containing employee information may need to be shared between multiple processes. Also, assume that the Department class comprises a number of instances of Employee classes. As shown in FIG. 9, in the code sample 900, when a new Department object is created in a memory space local to a process (e.g., 410) at 910 and assigned to a shared name space at 920 that causes the new Department object to be copied into the shared memory space (e.g., 440). Furthermore, placing the Department object within shared memory may cause any existing Employee objects (containing employee related information) also to be implicitly placed in shared memory 440. However, if new Employee objects are added with a local memory space of a process 410 then such objects may need to be explicitly flushed. FIG. 10 illustrates a code sample 1000 wherein a new Employee object is instantiated at 1010. Then at 1020 a lock may be obtained so that only one process at a time (e.g., 410) is updating a Department object with new Employee objects. Then at 1030, after obtaining a connection with copy share helper 430 a refreshAll(dept) method is called to ensure that any changes to the shared Department object's state that may have been caused by another process (e.g., 420) is reflected in the process (e.g., 410) adding the new Employee object. Later at 1035, the new Employee object is added and then at 1040 the updated Department object is explicitly flushed to a shared memory 440.

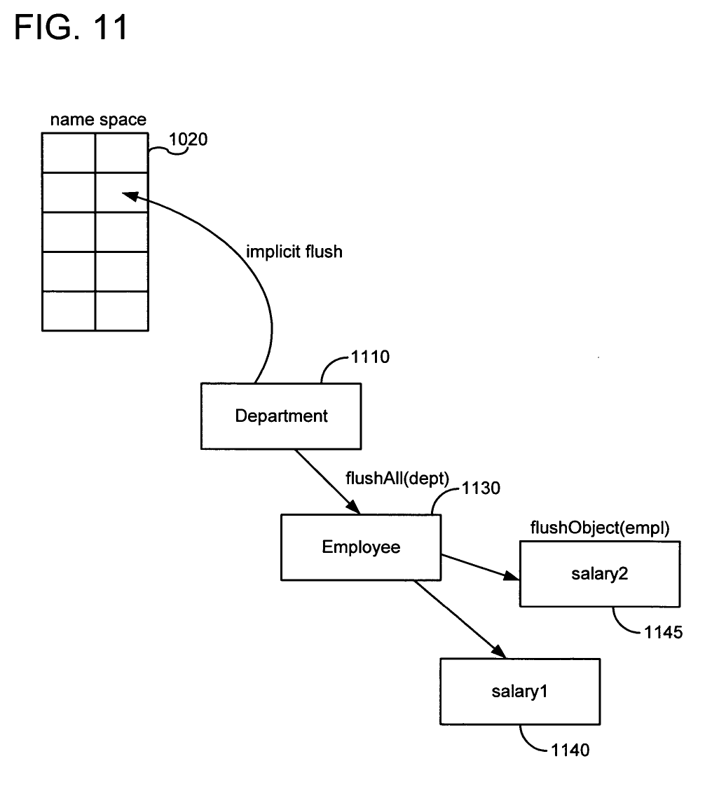

FIG. 11 illustrates the operation of the code sample 1000 further. The assigning of a Department object 1110 to a shared name space 1120 implicitly flushes the Department object 1110 and any existing Employee object to shared memory. Later when a new Employee object 1130 is created within a local memory space and added to the Department object 1110, a copy of the Department object 1110 in the shared memory may be explicitly updated by flushing the Department object along with the updated Employee object 1130 to shared memory. Thus, a flushAll method may need to be used to flush not only Department object but also the Employee object it refers to. Furthermore, suppose there is a salary field associated with each Employee object, then when the Employee object is flushed to shared memory its initial salary field 1140 is also flushed to shared memory. However, when the salary is changed by a process to the salary 2 at 1145 then an explicit flush of the updated Employee object with the new salary may be called to ensure that the salary change is reflected in shared memory. In this example, the argument for the flushObject method is only the Employee object not the parent Department object because the change was only within the salary field of the Employee object. Thus, the flushAll and flushObject methods may be used appropriately to update shared memory state selectively. The same applies to the refreshAll and refreshObject methods.

### Alternatives

Having described and illustrated the principles of our invention with reference to the described embodiments, it will be recognized that the described embodiments can be modified in arrangement and detail without departing from such principles.

Also, it should be understood that the programs, processes, or methods described herein are not related or limited to any particular type of computer apparatus. Various types of general purpose or specialized computer apparatus may be used with or perform operations in accordance with the teachings described herein. Actions described herein can be achieved by computer-readable media comprising computer-executable instructions for performing such actions. Elements of the illustrated embodiment shown in software may be implemented in hardware and vice versa. In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a system comprising multiple virtual machines, the multiple virtual machines being capable of concurrently executing multiple processes, a method of sharing one or more data objects between the multiple processes:
receiving an instruction to flush a state of the one or more data objects from a local memory location of at least one of the multiple processes concurrently executing on the multiple virtual machines; and
in response to receiving the instruction, flushing the state of the one or more data objects from the local memory location to a shared memory location.

2. The method of claim 1, wherein the shared memory location is accessible to the multiple processes concurrently executing on the multiple virtual machines.

3. The method of claim 1, wherein flushing the state of the one or more data objects from the local memory location comprises placing a new copy of the one or more data objects in the shared memory location.

4. The method of claim 1, wherein flushing the state of the one or more data objects from the local memory location comprises updating an existing state of an existing copy of the one or more data objects in the shared memory.

5. The method of claim 1, wherein the instruction to flush is an explicit flush instruction and the explicit instruction to flush the state of the one or more data objects from the local memory location causes an implicit flush of all other objects referred to within the one or more data objects in the local memory location.

6. The method of claim 1, wherein the flushing the state of the one or more data objects from the local memory location to a shared memory location comprises determining that the one or more data objects in the local memory location is defined to be serializable and placing a serialized form of the state of the data object in the shared memory location.

7. The method of claim 6, further comprising reading a custom serialization contract and generating the serialized form of the state of the data object according to the custom serialization contract.

8. The method of claim 1, wherein the flushing the state of the one or more data objects from the local memory location to a shared memory location comprises determining that the one or more data objects in the local memory is not defined to be serializable and using data reflection to determine the state of the of the one or more data objects in the local memory location.

9. In a system comprising multiple virtual machines, the multiple virtual machines being capable of concurrently executing multiple processes, a method of sharing one or more data objects between the multiple processes:
receiving an instruction to refresh a state of the one or more data objects in a local memory location corresponding to one of the multiple processes concurrently executing on the multiple virtual machines; and
in response to receiving the instruction to refresh, refreshing the state of the one or more data objects in the local memory location with another state of the one or more data objects from a shared memory location.

10. The method of claim 9, wherein refreshing the state of the one or more data objects in the local memory location comprises placing a new copy of the one or more data objects from the shared memory location in the local memory location.

11. The method of claim 9, wherein refreshing the state of the one or more data objects in the local memory location comprises updating an existing state of an existing copy of the data object in the local memory location.

12. The method of claim 9, wherein the instruction to refresh is an explicit refresh instruction and the explicit instruction to refresh the state of the one or more data objects in the local memory location causes an implicit refresh of all other objects referred to within the one or more data objects.

13. The method of claim 9, wherein the refreshing comprises determining that the one or more data objects is defined to be serializable and placing a serialized form of the state of the one more data object in the local memory location.

14. The method of claim 9, further comprising reading a custom serialization contract associated with the one or more data objects and generating the serialized form of the state of the one or more data objects from the shared memory location according to the custom serialization contract.

15. The method of claim 9, wherein copy sharing comprises determining that the one or more data objects is not defined to be serializable and using data reflection to determine the state of the of the one or more data objects in the shared memory location.

16. A system for sharing one or more data objects between multiple computer processes concurrently executing on multiple virtual machines, the system comprising:
at least one local memory location corresponding to at least one of the multiple processes;
at least one shared memory location accessible to the concurrently executing multiple processes; and
a copy sharing helper for brokering copy sharing of the one or more data objects between the multiple processes via the at least one shared memory location.

17. The system of claim 16, wherein the copy sharing helper is operable for receiving an instruction to copy share a state of the one or more data objects in the at least one local memory location and in response to the instruction to copy share, flushing the state of the one or more data objects from the at least one local memory location to the at least one shared memory location.

18. The system of claim 17, wherein flushing the state of the one or more data objects from the at least one local memory location to the at least one shared memory location comprises updating an existing state of an existing copy of the one or more data objects in the at least one shared memory location with the state of the one or more data objects from the at least one local memory location.

19. The system of claim 17, wherein flushing the state of the one or more data objects from the at least one local memory location to the at least one shared memory location comprises generating a new copy of the one or more data objects for the at least one local memory location.

20. The system of claim 16, wherein the copy sharing helper is operable for receiving an instruction to copy share a state of the one or more data objects in the at least one shared memory location and in response to the instruction to copy share, refreshing the at least one local memory location with the state of the one or more data objects from the shared memory location.

21. The system of claim 20, wherein refreshing the at least one local memory location with the state of the one or more data objects from the at least one shared memory location comprises updating an existing state of an existing copy of the one or more data objects in the at least one local memory location with the state of the one or more data objects from the at least one shared memory location.

22. The system of claim 20, wherein refreshing the at least one local memory location with the state of the one or more data objects from the at least one shared memory location comprises generating a new copy of the one or more data objects for the at least one local memory location.

23. At least one computer-readable media having stored thereon computer-executable instructions related to a function responsive to a function call from a first software component, the function comprising:
an input parameter indicative of a data object to be copy shared between multiple processes which are executing concurrently on multiple virtual machines; and
executable software for receiving the input parameter indicative of the data object to be copy shared and causing the data object to be copy shared between the multiple processes.

24. The at least one computer-readable media of claim 23, wherein causing the data object to be copy shared comprises flushing a state of the data object represented in a local memory of one or more of the multiple processes to a shared memory location.

25. The at least one computer-readable media of claim 23, wherein causing the data object to be copy shared comprises refreshing a state of the data object represented in a local memory location of one or more of the multiple processes with another state of the data object from a shared memory location.
